(19) United States
(12) Patent Application Publication
(10) Pub. No.: US 2012/0310934 A1
(43) Pub. Date: Dec. 6, 2012

(54) Historic View on Column Tables Using a History Table

(76) Inventors: Thomas Peh, Heidelberg (DE); Wolfgang Stephan, Heidelberg (DE); Andreas Tonder, Leimen (DE)

(21) Appl. No.: 13/153,333

(22) Filed: Jun. 3, 2011

(51) Int. Cl. G06F 17/30

(52) U.S. Cl. 707/736; 707/E17.009

(57) ABSTRACT

A computer-implemented system and method for providing an historical view of a data record are disclosed. A data record is stored in main memory of a server computer. An instruction to update the data record is received, and the instruction to update the data record is executed to provide a most recent version of the data record. A history table is generated that includes a main table part that represents the most recent version of the data record after the data record is updated, and a history table part that represents one or more past versions of the data record before the data record is updated. The history table is stored in the main memory of the server computer.

### BACKGROUND

This disclosure relates generally to in-memory computing, and more particularly to database history tables implemented inside a columnar engine of an In-Memory Computing Engine (IMCE). By means of time-travel queries on history tables, arbitrary historical states can be reconstructed.

In-memory computing (IMC) describes server systems that utilize a server's main memory as primary storage. In IMC, a database is stored in main memory in a column-oriented structure, which allows for compression of business data and partitioning for massive parallelization. As such, the database in an IMC system is directly accessible by the server's central processing unit (CPU) for fast access to data. Massive amounts of data stored on an in-memory database, therefore, can be queried and analyzed in transactions in real time and with very high speed, for near-instantaneous results which can be presented to a user as a “view”. Transactional views on a database table are computed by means of internal entities such as a “transaction token” and “Udiv-Manager.” A transactional view is simply represented by a bitmask over all rows being visible for the corresponding transaction.

In order to maximize the advantages of IMC, the in-memory database must be structured and used efficiently. Normally, when an internal restructuring operation of the in-memory database takes place (sometimes called a “delta-merge operation”), old versions of records, which are not visible for any of the existing transactions, are physically deleted from the table so that tasks performed on the main memory are more efficient. Accordingly, it is desirable that the most relevant data, such as the most recent versions of records, is always stored close to the CPU. However, such a scheme does not allow the server to reconstruct views on history tables at arbitrary points in time in history.

### SUMMARY

In general, this document discloses providing an historical view on column tables using a history table for an in-memory database.

In one aspect, a computer-implemented method for providing an historical view of a data record is disclosed. The method includes storing the data record in main memory of a server computer, receiving an instruction to update the data record, and executing the instruction to update the data record to provide a most recent version of the data record. The method further includes generating a history table. The history table includes a main table part that represents the most recent version of the data record after the data record is updated, and a history table part that represents one or more past versions of the data record before the data record is updated. The history table is stored in the main memory of the server computer.

In another aspect, a computer-implemented method includes storing a data record in main memory of a server computer, where the main memory is a random access memory such as RAM or DRAM. The method further includes receiving an instruction to update the data record, updating the data record according to the instruction to provide a most recent version of the data record, and generating a history table associated with the data record in the main memory. The method further includes storing, in the main memory, the most recent version of the data record in a main table part of the history table after the data record is updated and the past version of the data record before the data record is updated in a history table part of the history table.

In yet another aspect, a system for providing an historical view of a data record includes a processor, a main memory comprised of random access memory, and a database formed in the main memory. The database includes a row storage that stores row data of a data table associated with the data record, and a column storage that stores column data of the data table associated with the data record. The system further includes a history table formed in the column storage of the database. The history table includes a main table part that represents a most recent version of the data record after the data record is updated by the processor executing an instruction to update the data record, and a history table part that represents one or more past versions of the data record before the data record is updated.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates an in-memory computing engine having a history table for providing an historic view.

FIG. 2A illustrates the main table part and history table part of an exemplary history table after executing a DML operation.

FIG. 2B illustrates an exemplary result set of a search transaction for a historical view.

FIG. 3 is a flowchart of a method for providing an historical view on column tables using a history table in an in-memory database.

Like reference symbols in the various drawings indicate like elements.

### DETAILED DESCRIPTION

This document describes a system and method for providing an historical view on column tables using a history table for an in-memory database. In particular, the column store of the IMCE provides a special kind of database table, called a “history table”. In contrast to normal database tables, data manipulation language (DML) operations like UPDATE or DELETE will not lead to physical deletion of records. Instead, all overwritten and deleted records will be kept inside a separate part of the table. The transfer of the updated/deleted records (which are no longer visible for any open read transaction) to the history part of the table is done during delta merge reorganization operation. The history table part is organized as insert-only table without key. By storing the historical data in such a manner, the server is able to reconstruct views on history tables at arbitrary points in time in history. The physical separation of old and recent data allows fast access to the relatively small recent data which fits well into processor caches, whereas the potential large historical data can be stored and processed on additional hardware or swapped out of memory if the application does require historical views on data only occasionally.

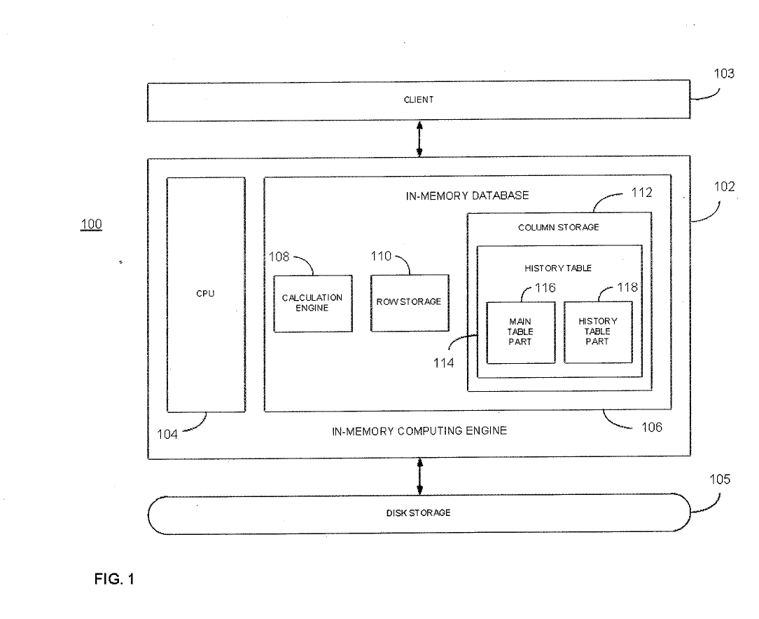

FIG. 1 illustrates an in-memory computing engine (IMCE) 102 for executing high speed analytics on business data. One example of the IMCE 102 is the In-Memory Appliance named HANA™ developed by SAP AG of Walldorf, Germany. The IMCE 102 is a hardware and software platform that enables real-time transactional analysis of huge amounts of business data stored in main memory of a server system. The IMCE 102 executes one or more business applications directed by a client computer 103, such as enterprise resource planning (ERP), customer relationship management (CRM), or business intelligence (BI) on any available data in an in-memory database 106. The IMCE 102 can also persist other sources of data and result records in a disk storage 105 for long-term storage or secondary access.

The IMCE 102 includes a CPU 104, implemented as a data processor, for executing software instructions and DML operations on data stored in the in-memory database 106. The in-memory database 106 is implemented as main memory such as dynamic random access memory (DRAM) or other solid state memory, and includes a calculation engine 108, a row storage 110, and a column storage 112.

In accordance with exemplary preferred implementations, the column storage 112 of the in-memory database 106 includes a history table 114 for providing an historic view of updated or deleted database records at arbitrary points in time. The history table 114 includes a main table part 116 and of a history table part 118. Each of the main table part 116 and history table part 118 additionally has a delta-table (not shown) for fast updates.

Using the history table 114, the IMCE 102 keeps old versions of records and transfers them to the history table part 118 of the history table 114. The main table part 116 contains the most recent view of the data, while the history table part 118 contains older versions of the data. When DML-operations are executed on the history table 114, updated and deleted records will be created in the main table part 116.

In addition to normal database tables, each history table 114 is equipped with two technical attributes ($validfrom$, $validto$, or similar attributes) which contain the validity period for each record (i.e. the commit-id of insertion and commit-id of deletion). As an example, under request from the client 103, the IMCE 102 can turn back a database transaction to a certain point in time by executing the following SQL statement:

### ALTER SESSION RESTORE WITH TIMESTAMP ‘2010-10-01 12:00:00’

When this statement is executed, a flag is set inside the transaction token in the in-memory database 106, indicating that follow-on queries should also search in the history table part 118 of the history table 114. Further, the timestamp is used to compute a commit-id (CID) that was valid at that time (by a lookup in a special system table TRANSACTION_HISTORY) which is also written into the transaction token.

In accordance with exemplary preferred implementations, a time travel query (i.e. a query executed in a restored session) can be computed as follows. Let TAB (X INT, Y INT) be a history table with the following statement history:

INSERT INTO TAB VALUES (1,100)
INSERT INTO TAB VALUES (2,200)
COMMIT

( let the CID be 20 and the system time be ‘2010-10-
01 12:00:00’ )

UPDATE TAB SET Y=201 WHERE X=2
COMMIT (let the CID be 30)

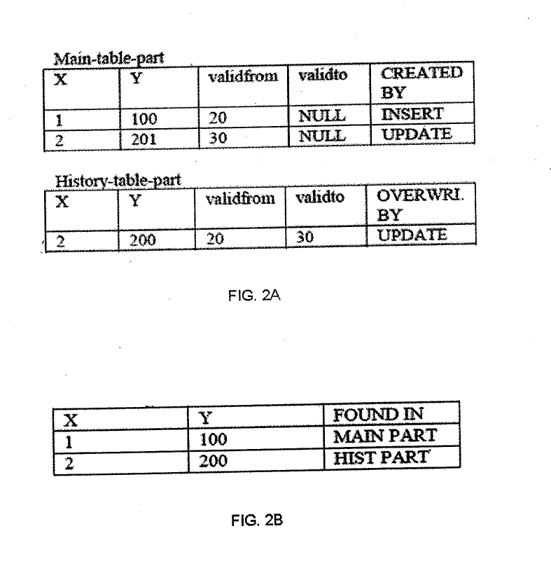

After executing these statements, the internal parts of the history table are provided, as illustrated in FIG. 2A.

By way of an example, when the query SELECT x, y FROM TAB is executed in a restored session with timestamp ‘2010-10-01 12:00:00’ and the CID for that timestamp is 25, to determine the bitmasks which define the visibility for the restored transaction, this query will be divided into two searches: one on the main table part 116 and one on the history table part 118. Both searches are restricted by the condition:

$validfrom$ <= CID and (CID < $validto$ or CID IS NULL)
and the resulting bitmasks in the example are [0,1] for the main table part 116, and [1] for the history table part 118. These bitmasks are then used to materialize the final result. Regarding the example with CID=25, the result set is shown in FIG. 2B, and is the state of the table TAB after the first COMMIT.

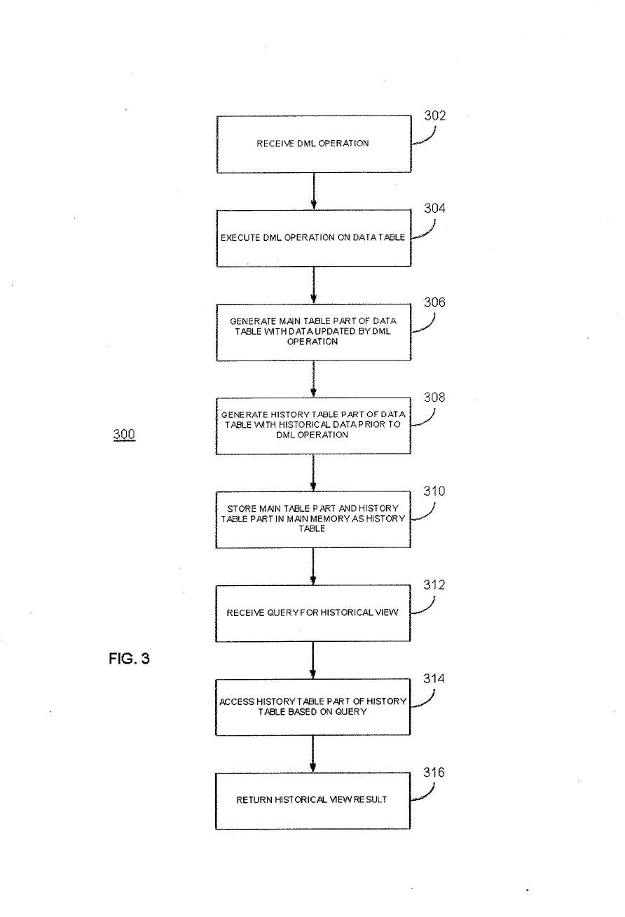

FIG. 3 is a flowchart of a method 300 for providing an historical view on column tables using a history table in an in-memory database as part of an IMCE. At 302, a DML operation such as UPDATE or DELETE is received by the IMCE, to update a data table in the in-memory database. At 304, the DML operation is executed on the relevant data table. At 306, a main table part of a history table is generated with the updated data as executed according to the DML operation, and at 308 a history table part of the history table is generated with historical data, i.e. older versions of records of the data table prior to the DML operation. At 312, the main table part and the history table part are stored in main memory as a history table of an in-memory database.

At 312, a query is received by the IMCE for an historical view of the data table, i.e. a view of the data table at some arbitrary point in time. At 314, the history table part relating to a timestamp associated with the query is accessed, and at 316 a historical view of the result is returned by the IMCE. If the timestamp includes the most recent view of the data as well as an historical view, the IMCE will also access the main table part of the history table at 314, and at 316 return a most recent view of the result.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate implementations, may also be provided in combination in a single implementation. Conversely, various features which, for brevity, are described in the context of a single implementation, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method for providing an historical view of a data record, the method comprising:
storing the data record in main memory of a server computer;
receiving an instruction to update the data record;
executing the instruction to update the data record to provide a most recent version of the data record; and
generating a history table, the history table comprising a main table part that represents the most recent version of the data record after the data record is updated, and a history table part that represents one or more past versions of the data record before the data record is updated, the history table being stored in the main memory of the server computer.

2. The computer-implemented method in accordance with claim 1, wherein the history table further includes at least two attributes that define terminal points of time of a validity period for each version of the data record.

3. The computer-implemented method in accordance with claim 1, wherein the instruction to update the data record is a data manipulation language (DML) instruction.

4. The computer-implemented method in accordance with claim 1, wherein the history table further includes a transaction token that represents a timestamp for a transaction associated with each instruction to update the data record.

5. The computer-implemented method in accordance with claim 1, wherein executing the instruction to update the data record further includes:
computing a commit identifier that provides a timestamp for a transaction associated with the instruction to update the data record.

6. The computer-implemented method in accordance with claim 5, further comprising storing the timestamp in the history table as a transaction token.

7. The computer-implemented method in accordance with claim 2, further comprising accessing the history table part of the history table according to a request for a view of the data record that corresponds to a validity period for a past version of the data record before the data record is updated.

8. A computer-implemented method comprising:
storing a data record in main memory of a server computer, the main memory being a random access memory;
receiving an instruction to update the data record;
updating the data record according to the instruction to provide a most recent version of the data record;
generating a history table associated with the data record in the main memory;
storing, in the main memory, the most recent version of the data record in a main table part of the history table after the data record is updated; and
storing, in the main memory, the past version of the data record before the data record is updated in a history table part of the history table.

9. The computer-implemented method in accordance with claim 8, wherein the history table further includes at least two attributes that define terminal points of time of a validity period for each version of the data record.

10. The computer-implemented method in accordance with claim 8, wherein the instruction to update the data record is a data manipulation language (DML) instruction.

11. The computer-implemented method in accordance with claim 8, further comprising computing a commit identifier that provides a timestamp for a transaction associated with the instruction to update the data record.

12. The computer-implemented method in accordance with claim 11, further comprising generating a transaction token that represents the timestamp for the transaction associated with the instruction to update the data record.

13. The computer-implemented method in accordance with claim 12, further comprising storing the transaction token in the history table in the main memory.

14. The computer-implemented method in accordance with claim 8, further comprising accessing the history table part of the history table according to a request for a view of the data record that corresponds to a validity person for a past version of the data record before the data record is updated.

15. The computer-implemented method in accordance with claim 8, further comprising accessing the history table part of the history table according to a request for a view of the data record that corresponds to a validity period for a past version of the data record before the data record is updated, and accessing the main table part of the history table if the validity period includes a time associated with the most recent version of the data record.

16. A system for providing an historical view of a data record, the system comprising:
a processor;
a main memory comprised of random access memory;
a database formed in the main memory, the database comprising a row storage that stores row data of a data table associated with the data record, and a column storage that stores column data of the data table associated with the data record; and
a history table formed in the column storage of the database, the history table comprising a main table part that represents a most recent version of the data record after the data record is updated by the processor executing an instruction to update the data record, and a history table part that represents one or more past versions of the data record before the data record is updated.

17. The system in accordance with claim 16, wherein the history table further includes at least two attributes that define terminal points of time of a validity period for each version of the data record.

18. The system in accordance with claim 16, the database further includes a transaction token that represents the timestamp for a transaction associated with the instruction to update the data record.
